(19) United States
(12) Patent Application Publication
(10) Pub. No.: US 2021/0269257 A1
(43) Pub. Date: Sep. 2, 2021

(54) APPARATUS AND METHOD FOR POSITIONING AN OBJECT

(71) Applicant: DIAMOND ONIONS, Dallas, TX (US)

(72) Inventors: Robert Kenneth Patteson, JR., Dallas, TX (US); Maximilian Sluiter, Thousand Oaks, CA (US); Daniel Samarin, Long Beach, CA (US); Matthew Michael O'Brien, Hermosa Beach, CA (US); Devid Volovskiy, Southfield, MI (US); Nicholas Michael Degnan, Redondo Beach, CA (US); Eric Michael Cosselman, Santa Barbara, CA (US)

(21) Appl. No.: 17/325,084

(22) Filed: May 19, 2021

Related U.S. Application Data
(63) Continuation of application No. PCT/US19/62250, filed on Nov. 19, 2019.
(60) Provisional application No. 62/769,443, filed on Nov. 19, 2018.

(51) Int. Cl. B65G 47/90; B25J 15/10

(52) U.S. Cl. CPC B65G 47/90; B25J 15/106

(57) ABSTRACT

The present disclosure provides an apparatus and method for positioning an object. The apparatus can include gripping elements or arms to grip the object and actuators to move the object. Methods for positioning the object can include rotating the object about a first and second axis to achieve the desired position.

### CROSS-REFERENCE TO RELATED APPLICATIONS

The present application is a continuation of PCT/US19/62250, filed Nov. 19, 2019, which claims the benefit of U.S. Provisional Application No. 62/769,443, filed on Nov. 19, 2018 entitled, “Apparatus and Method for Positioning an Object”, the entirety of which are incorporated herein by reference.

### BACKGROUND

Objects such as onions or other produce are often processed mechanically. This processing can include things such as chopping or peeling. To achieve this processing, objects often need to be loaded into a machine that mechanically processes the object. A challenge to loading objects into a processing machine is when the object is imperfectly spherical, such that its orientation going into the machine must be corrected in order to optimally process the object. Objects such as onions that are imperfectly spherical, and vary in size, present a challenge to loading into a processing machine. Manually orienting an object can be burdensome where large quantities of objects need to be oriented. As such, what is needed is an apparatus and method for accurately positioning an object on a surface.

### SUMMARY

The present disclosure is directed to an apparatus for positioning an object.

In one embodiment, the apparatus for positioning an object comprises four gripping elements, comprising two pairs of diametrically opposed gripping elements; four appendages, comprising two pairs of diametrically opposed appendages, operably connected to each of the four gripping elements; a vertical actuator, wherein the vertical actuator is operably connected to the four gripping elements, wherein the vertical actuator moves the four gripping elements vertically relative to the object; a horizontal actuator, wherein the horizontal actuator is operably connected to the four gripping elements, wherein the horizontal actuator moves each of the two pairs of diametrically opposed gripping elements from a first distance apart to a second distance apart, and wherein the second distance apart is sufficient to engage the object; and a rotational actuator, operably connected to the four appendages, wherein the rotational actuator rotates a first pair of the two pairs of diametrically opposed appendages in a first common direction about a first axis, wherein the rotational actuator rotates a second pair of the two pairs of diametrically opposed appendages in a second common direction about a second axis, wherein the second axis is perpendicular to the first axis.

In another embodiment, the apparatus for positioning an object comprises a frame; four arms arranged in radial symmetry around the frame, wherein the four arms comprise two pairs of diametrically opposed arms, wherein each arm comprises (i) a first end, wherein the first end is pivotly connected to the frame; (ii) a second end, wherein the arm extends vertically from the frame to the second end and wherein the second end is proximal to a surface; and (iii) an appendage, wherein the appendage is connected to the second end; a vertical actuator, wherein the vertical actuator is operably connected to the four arms, wherein the vertical actuator moves the four arms vertically toward the object, and wherein the vertical movement is determined by an object height; a horizontal actuator, wherein the horizontal actuator is operably connected to the four arms, wherein the horizontal actuator moves each of the two pairs of diametrically opposed arms from a first distance apart to a second distance apart, and wherein the second distance apart engages the object; and a rotational actuator, wherein the rotational actuator is operably connected to the appendage on each of the four arms, wherein the rotational actuator rotates the appendages on a first pair of the two pairs of diametrically opposed arms in a first common direction about a first axis, wherein the rotational actuator rotates the appendages on a second pair of the two pairs of diametrically opposed arms in a second common direction about a second axis, wherein the second axis is perpendicular to the first axis, each pair of the two pairs of diametrically opposed arms in a common direction to rotate the object.

In any of the foregoing embodiments, the apparatus for positioning an object further comprises a camera to capture at least one image of the object; an image processor configured to receive input from the camera, and a controller configured to direct movement of the rotational actuator, wherein the controller determines a rotational profile of the object and directs movement of the rotational actuator based on the rotational profile.

In any of the foregoing embodiments, the rotational profile of the apparatus for positioning an object is based on an object feature.

In any of the foregoing embodiments, the image processor comprises a pattern recognition algorithm.

In any of the foregoing embodiments, the apparatus for positioning an object further comprises a first height sensor operably connected to the vertical actuator, wherein the first height sensor measures a first height of the object above a surface, and wherein the first height of the object above the surface is the object height that determines the amount of vertical movement of the gripping elements by the vertical actuator.

In any of the foregoing embodiments, the apparatus for positioning an object further comprises a second vertical actuator, wherein the second vertical actuator is positioned below the four gripping elements, wherein the second vertical actuator moves the object vertically toward the four gripping elements, and wherein the vertical movement is determined by a second object height.

In any of the foregoing embodiments, the second vertical actuator of the apparatus for positioning an object comprises an end proximal to the object and an end distal to the object, wherein the end proximal to the object comprises fingers, and wherein the object rests on top of the fingers.

In any of the foregoing embodiments, the apparatus for positioning an object further comprises a light fixture.

In any of the foregoing embodiments, the light fixture of the apparatus for positioning an object is arranged in radial symmetry around the four gripping elements.

In any of the foregoing embodiments, the light fixture comprises a flat board surrounding the camera.

In any of the foregoing embodiments, the apparatus for positioning an object further comprises four arms, each arm comprising a first end and a second end, wherein the first end is pivotly connected to a frame, wherein each of the four arms extends vertically from the frame to the second end, wherein the second end is proximal to the object, and wherein the second end of each arm comprises one of the four gripping elements.

In any of the foregoing embodiments, the apparatus for positioning an object further comprises a controller, wherein the controller is operably connected to the four gripping elements and the four appendages, wherein the controller controls movement of the vertical actuator, the horizontal actuator, and the rotational actuator.

In any of the foregoing embodiments, the apparatus for positioning an object further comprises a second vertical actuator, wherein the second vertical actuator is positioned below the four arms, wherein the second vertical actuator moves the object vertically toward the four arms, and wherein the vertical movement is determined by a second object height.

In any of the foregoing embodiments, the light fixture of the apparatus for positioning an object is arranged in radial symmetry around the four arms.

The present disclosure is also directed to a method for positioning an object.

In one embodiment, the method for positioning an object comprises measuring the object height with a height sensor; moving the four gripping elements vertically toward the object with the vertical actuator; moving a first pair of the two pairs of diametrically opposed gripping elements horizontally toward the object; gripping the object with the first pair of the two pairs of diametrically opposed gripping elements; lifting the object with the first pair of the two pairs of diametrically opposed gripping elements; rotating the object about the first axis with the first pair of the two pairs of diametrically opposed appendages; gripping the object with a second pair of the two pairs of diametrically opposed gripping elements; releasing of the object by the first pair of the two pairs of diametrically opposed gripping elements; and rotating the object about the second axis with the second pair of the two pairs of diametrically opposed appendages.

In another embodiment, the method for positioning an object comprises measuring the object height with a height sensor; moving the four arms vertically toward the object with the vertical actuator; moving the first pair of the two pairs of diametrically opposed arms horizontally toward the object with the horizontal actuator; gripping the object with the gripping elements on the first pair of the two pairs of diametrically opposed arms; lifting the object; rotating the object about the first axis with the rotational actuator operably connected to gripping elements on the first pair of the two pairs of diametrically opposed arms; gripping the object with the gripping elements on the second pair of the two pairs of diametrically opposed arms; releasing the object with the first pair of the two pairs of diametrically opposed arms; and rotating the object about the second axis with the rotational actuator operably connected to gripping elements on the second pair of the two pairs of diametrically opposed arms.

In another embodiment, the method for positioning an object further comprises the steps of measuring a second object height with a second height sensor, wherein the second object height is the height of the object below the surface; and moving the object vertically toward the four arms with a second vertical actuator, wherein the second vertical actuator is positioned below the four arms, and wherein the vertical movement of the second vertical actuator is determined by the second object height.

In any of the foregoing embodiments, the height sensor in the method for positioning an object senses a height of the object above the surface.

In any of the foregoing embodiments, the method for positioning an object further comprises the steps of measuring a second object height with a second height sensor, wherein the second object height is the height of the object below a surface; and moving the object vertically toward the four gripping elements with a second vertical actuator, wherein the second vertical actuator is positioned below the four gripping elements, and wherein the vertical movement of the second vertical actuator is determined by the second object height.

In any of the foregoing embodiments, the second vertical actuator of the method for positioning an object comprises an end proximal to the object and an end distal to the object and wherein the end proximal to the object comprises fingers.

In any of the foregoing embodiments, the method for positioning an object further comprises the steps of detecting the object with a camera, wherein the camera captures at least one image of the object; and creating the rotational profile of the object to determine the amount of rotation.

In any of the foregoing embodiments, the step of creating the rotational profile of the object in the method for positioning an object further is accomplished by a controller.

In any of the foregoing embodiments, the rotational profile of the step of creating the rotational profile of the object is based on the feature of the object.

In any of the foregoing embodiments, the method for positioning an object further comprises the step of exposing the object to a light.

In any of the foregoing embodiments, the object in the method for positioning an object comprises a spherical object.

In any of the foregoing embodiments, the object in the method for positioning an object comprises an onion.

In another embodiment, the method for positioning an object comprises exposing the object to a first sensor to measure a first dimension of the object; transmitting a first signal based on the first dimension from the first sensor to a controller, wherein the controller signals a movement to place the object in position for capturing a first image of the object; capturing the first image of the object thereby creating a second signal; transmitting the second signal to the controller, wherein the controller is programmed to create a first rotational profile along a first axis; and rotating the object along the first axis based on the first rotational profile.

In any of the foregoing embodiments, the method may further comprise the following steps after the object is rotated along the first axis: capturing a second image of the object thereby creating a third signal; transmitting the third signal to the controller, wherein the controller is programmed to create a second rotational profile along a second axis; and rotating the object along the second axis based on the second rotational profile.

In any of the foregoing embodiments, the method may further comprise, prior to transmitting a first signal based on the first dimension from the first sensor to a controller, exposing the object to a second sensor to measure a second dimension of the object, wherein the first signal is also based on the second dimension from the second sensor.

In any of the foregoing embodiments, the method may further comprise, prior to capturing the first image of the object, exposing the object to a light source.

In any of the foregoing embodiments, wherein the second signal is generated by a pattern recognition algorithm.

In any of the foregoing embodiments, wherein the first rotational profile is based on at least one object feature.

In any of the foregoing embodiments, the method may further comprise, prior to capturing the second image of the object, exposing the object to a light source.

In any of the foregoing embodiments, wherein the third signal is generated by a pattern recognition algorithm.

In any of the foregoing embodiments, wherein the second rotational profile is based on at least one object feature.

In any of the foregoing embodiments, wherein the second axis is perpendicular to the first axis.

In any of the foregoing embodiments, wherein the first sensor is operably connected to a vertical actuator, wherein the vertical actuator is operably connected to four gripping elements comprising two pairs of diametrically opposed gripping elements.

In any of the foregoing embodiments, wherein the second sensor is operably connected to a vertical actuator, wherein the vertical actuator is operably connected to four gripping elements comprising two pairs of diametrically opposed gripping elements.

In any of the foregoing embodiments, wherein the first sensor and the second sensor are operably connected a vertical actuator, wherein the vertical actuator is operably connected to four gripping elements comprising two pairs of diametrically opposed gripping elements.

In any of the foregoing embodiments, wherein the steps of capturing the first image of the object and capturing a second image of the object are performed by a camera, wherein the camera is operably connected to the image processor, and wherein the image processor is operably connected to the controller.

In any of the foregoing embodiments, wherein the steps of rotating the object along the first axis and rotating the object along the second axis are performed by a rotational actuator, wherein the rotational actuator is operably connected to four appendages, wherein the four appendages comprise two pairs of diametrically opposed appendages.

In any of the foregoing embodiments, wherein the two pairs of diametrically opposed appendages comprise a first pair of diametrically opposed appendages and a second pair of diametrically opposed appendages, wherein the first pair of diametrically opposed appendages rotates the object along the first axis, and wherein the second pair of diametrically opposed appendages rotates the object along the second axis.

### BRIEF DESCRIPTION OF THE DRAWINGS

FIGS. 1-10 are schematic depictions of the method of positioning an object using an embodiment of the apparatus.

FIG. 1 is a schematic depiction of a side view of measuring the height of an object with a height sensor.

FIG. 2 is a schematic depiction of a side view of measuring a second height of an object with a second height sensor.

FIG. 3 is a schematic depiction of a side view of vertical movement of the gripping elements toward the object and vertical movement of the object toward the gripping elements.

FIG. 4 is a schematic depiction of a top-down perspective of horizontal movement of a first pair of diametrically opposed gripping elements toward the object to grip the object.

FIG. 5 is a schematic depiction of a top-down perspective of rotational movement of the appendage of the first pair of diametrically opposed gripping elements to rotate the object.

FIG. 6 is a schematic depiction of a top-down perspective of horizontal movement of a second pair of diametrically opposed gripping elements to grip the object and horizontal movement of the first pair of diametrically opposed gripping elements to release the object.

FIG. 7 is a schematic depiction of a top-down perspective of rotational movement of the appendage of the second pair of diametrically opposed gripping elements to rotate the object.

FIG. 8 is a schematic depiction of a side view of vertical movement of the gripping elements toward a surface.

FIG. 9 is a schematic depiction of a side view of horizontal movement of the second pair of diametrically opposed gripping elements to release the object.

FIG. 10 is a schematic depiction of a side view of vertical movement of the gripping elements away from the object and vertical movement of the object away from the gripping elements.

FIG. 11 is a simplified perspective view of one embodiment of an object positioning apparatus having four arms.

FIG. 12 is a detailed perspective view of one embodiment of an object positioning apparatus having four arms.

FIG. 13 is a detailed perspective view of one embodiment of an object positioning apparatus having four arms and a camera.

FIG. 14 is a flow diagram depicting an embodiment of the method of positioning an object.

### DETAILED DESCRIPTION

The current invention is directed to an apparatus and method for positioning an object. The apparatus and method provide for positioning of objects of non-uniform size and shape to a desired position.

The present invention comprises four gripping elements capable of three different types of movement. The gripping elements may move vertically toward an object, horizontally toward the object, and rotate in a common direction so as to rotate the object. To provide this movement, the apparatus comprises a vertical actuator, horizontal actuator, and rotational actuator. The apparatus may further comprise a camera to capture at least one image of the object and an image processor configured to receive input from the camera. The image processor may comprise a pattern recognition algorithm that extracts one or more features of the object and registers the one or more features along an orientation axis. The apparatus may further comprise a controller configured to determine a rotational profile of the object features and direct movement of the rotational actuator to rotate the object to the desired position. The apparatus may further comprise a one or more height sensors operably connected to the vertical actuator or a second vertical actuator, measuring the height of the object above or below a surface. The apparatus may further comprise a light fixture to shine light on the object. The apparatus may further comprise four arms extending from a frame, with gripping elements at the ends of the arms that contact the object to be positioned.

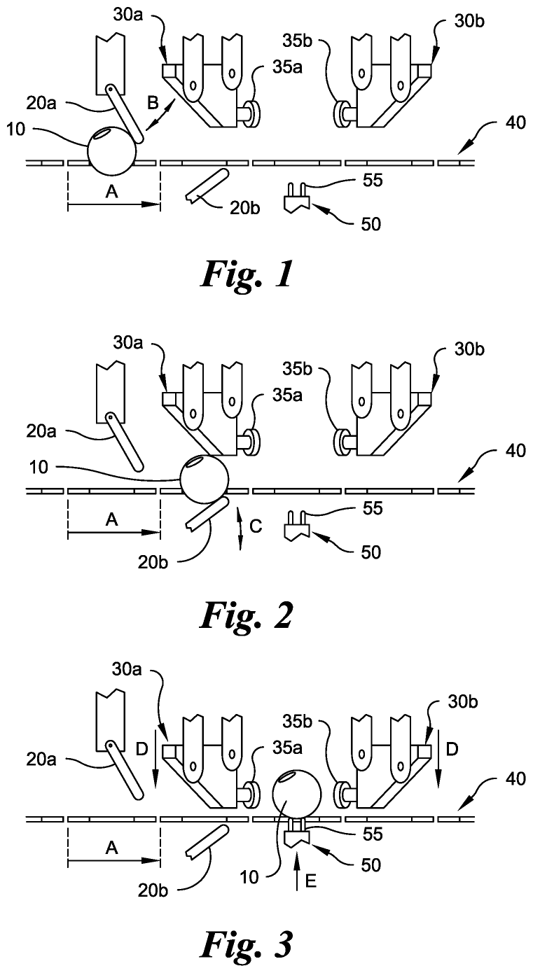

The schematics depicted in FIGS. 1-10 illustrate the movement of the apparatus in an embodiment to result in positioning of an object 10.

FIG. 1 depicts measuring the height of an object 10 with a height sensor 20a. In FIG. 1, as a surface 40 moves the object 10 along path A, a first height sensor 20a is displaced along path B, effectively measuring the height of the object 10 above the surface 40. The position of the first height sensor 20a is relayed to the vertical actuator (not depicted).

FIG. 2 depicts measuring a second height of an object 10 with a second height sensor 20b. In FIG. 2, as a surface 40 moves the object 10 along path A, a second height sensor 20b is displaced along path C, effectively measuring the height of the object 10 below the surface 40. The position of the second height sensor 20b is relayed to the second vertical actuator 50.

In some embodiments, the positions of the first height sensor 20a and the second height sensor 20b determine whether the second vertical actuator 50 engages. By way of example but not limitation, if the object position measured by the first height sensor 20a is below a threshold, the second vertical actuator 50 is engaged to lift the object. If the object position measured by the first height sensor 20a is above a threshold, the second vertical actuator 50 is not engaged and does not lift the object.

FIG. 3 depicts vertical movement of the gripping elements 30a, 30b toward the object 10 and vertical movement of the object 10 toward the gripping elements 30a, 30b. In FIG. 3, a surface 40 moves the object 10 along path A. Once the object 10 is centered below the gripping elements 30a, 30b, the vertical actuator moves the gripping elements 30a, 30b vertically toward the object 10 along path D and the object 10 is raised by a second vertical actuator 50 toward the gripping elements 30a, 30b along path E, where the object 10 rests on top of fingers 55 of the second vertical actuator 50.

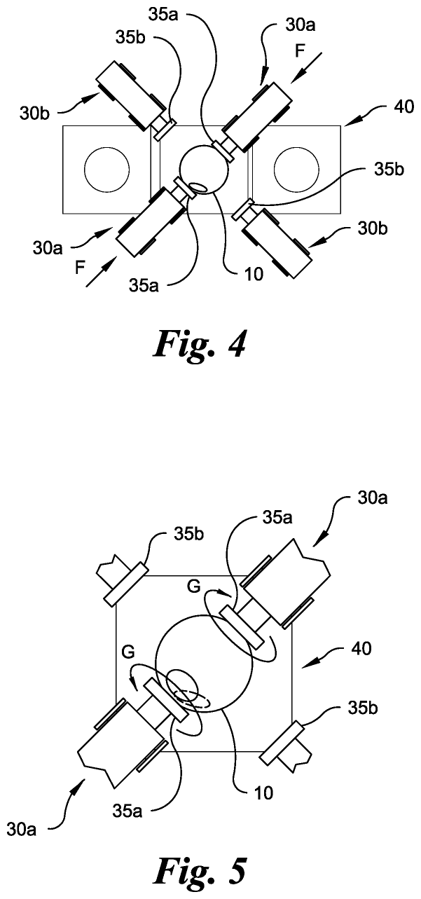

FIG. 4 depicts horizontal movement of a first pair of diametrically opposed gripping elements 30a toward the object 10 to grip the object 10. In FIG. 4, the horizontal actuator moves the first pair of diametrically opposed gripping elements 30a horizontally toward the object 10 along path F.

FIG. 5 depicts rotational movement of the appendage 35a of the first pair of diametrically opposed gripping elements 30a to rotate the object 10. In FIG. 5, the rotational actuator rotates the appendages 35a of the first pair of diametrically opposed gripping elements 30a in a common direction, i.e., in either direction along path G.

FIG. 6 depicts horizontal movement of a second pair of diametrically opposed gripping elements 30b to grip the object 10 and horizontal movement of the first pair of diametrically opposed gripping elements 30a to release the object 10. In FIG. 6, the horizontal actuator moves the second pair of diametrically opposed gripping elements 30b along path H toward the object 10 to grip the object 10. The horizontal actuator moves the first pair of diametrically opposed gripping elements 30a along path F away from the object 10 to release the object 10.

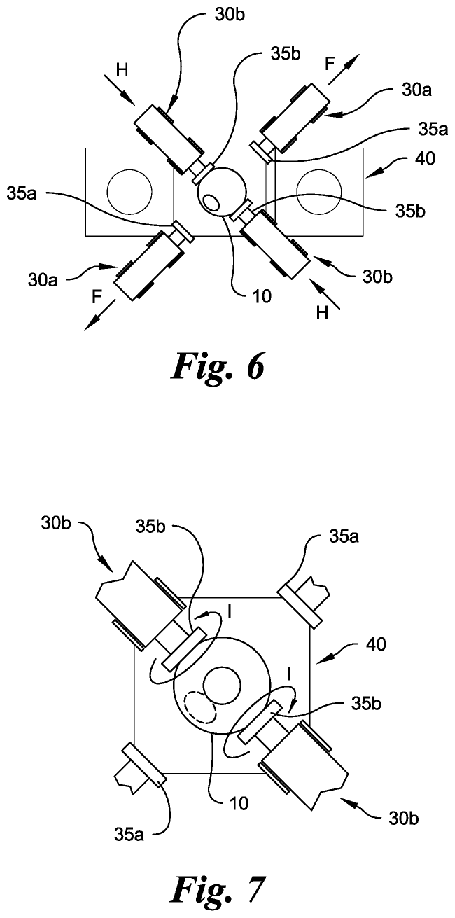

FIG. 7 depicts the rotational movement of the appendages 35b of the second pair of diametrically opposed gripping elements 30b to rotate the object 10. In FIG. 7, the rotational actuator rotates the appendages 35b of the second pair of diametrically opposed gripping elements 30b in a common direction, i.e., in either direction along path I.

FIG. 8 depicts vertical movement of the gripping elements 30a, 30b toward a surface 40. In FIG. 8, the vertical actuator moves the gripping elements 30a, 30b toward the surface 40 along path D, setting the object 10 on the surface 40.

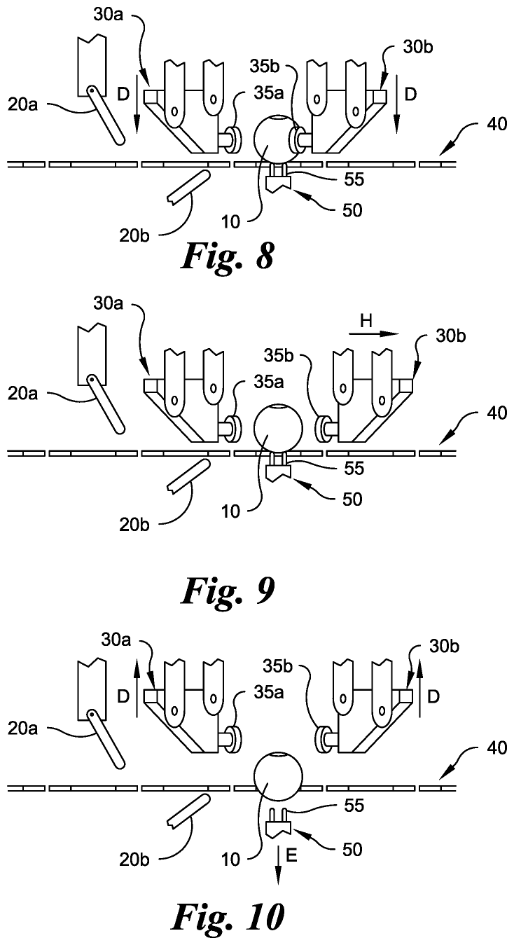

FIG. 9 depicts horizontal movement of the second pair of diametrically opposed gripping elements 30b to release the object 10. In FIG. 9, the horizontal actuator moves the second pair of diametrically opposed gripping elements 30b along path H away from the object 10.

FIG. 10 depicts vertical movement of the gripping elements 30a, 30b away from the object 10 and vertical movement of the object 10 away from the gripping elements 30a, 30b. In FIG. 10, the vertical actuator moves the gripping elements 30a, 30b vertically away from the object 10 along path D and the object 10 is lowered by a second vertical actuator 50 away from the gripping elements 30a, 30b along path E.

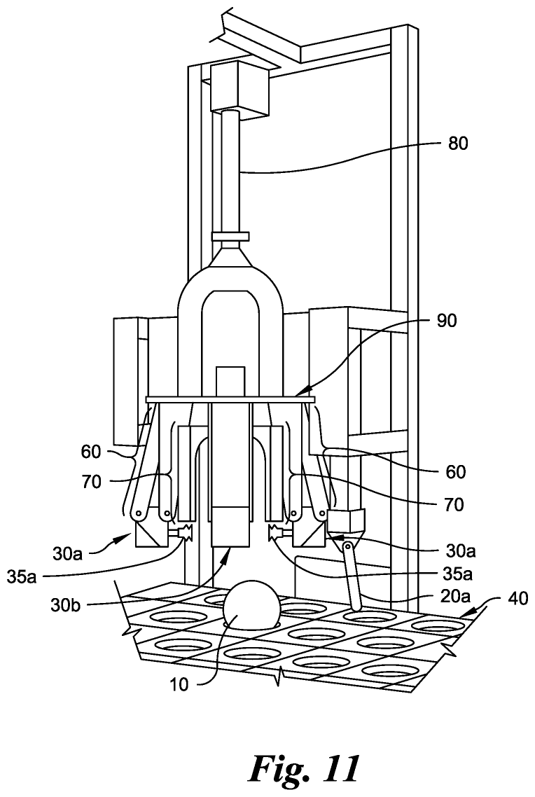

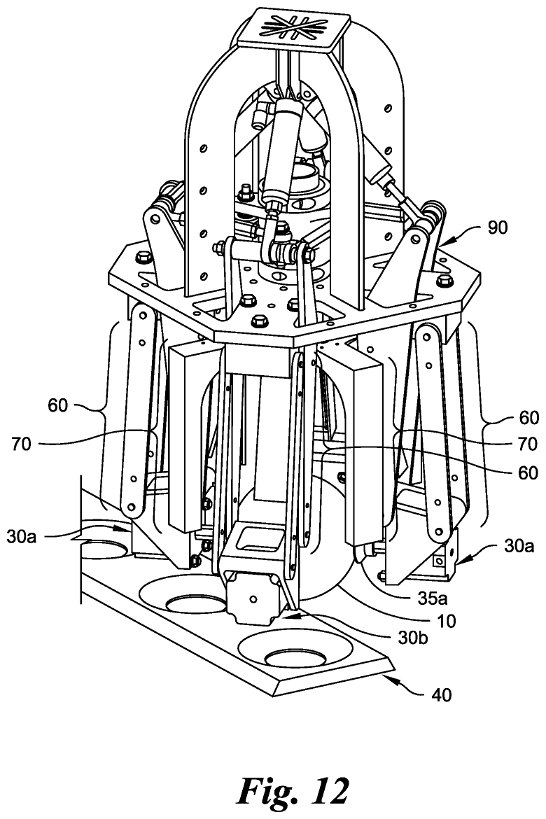

FIGS. 11-13 depict an embodiment of the invention comprising four arms 60 extending from a frame 90, the ends of the arms having gripping elements 30a, 30b that contact the object 10 to be positioned.

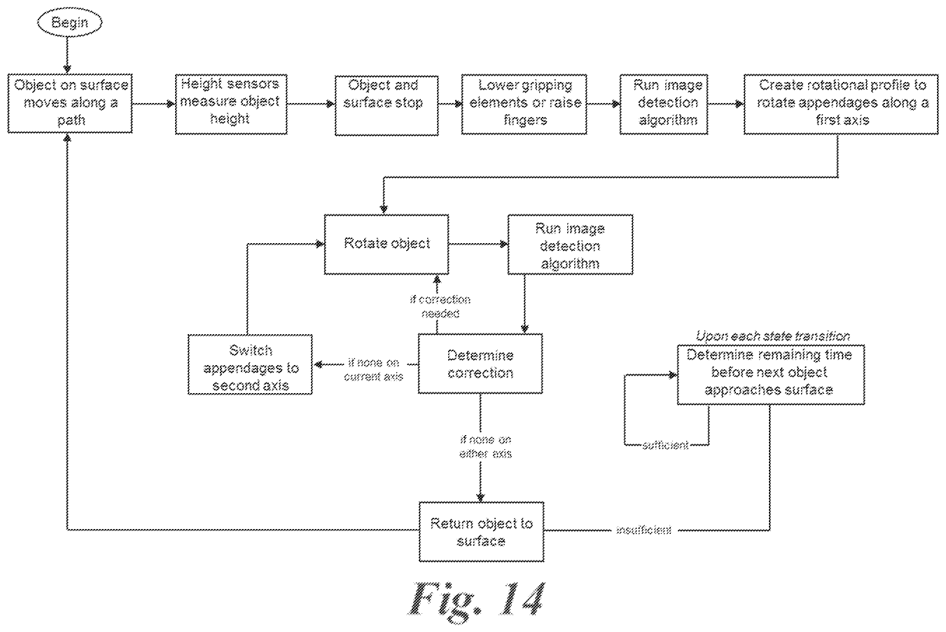

FIG. 14 is a flow diagram depicting an embodiment of the method of positioning an object. In an embodiment, an object on a surface moves along a path and height sensors measure the object height. The object and surface on which the object rests stop moving along the path. Based on the object height measured by the height sensors, the gripping elements lower to the object and/or the fingers raise the object. A pattern recognition algorithm registers features of the object along an orientation axis. In some embodiments, the pattern recognition algorithm is run on at least one image captured by a camera and processed by an image processor. A rotational profile representing the angle that the object must be rotated to achieve the desired orientation is created for appendage rotation. In some embodiments, this is carried out by the controller. The object is rotated along a first axis based on the rotational profile. In some embodiments, the pattern recognition algorithm is run on a second image captured by a camera and processed by an image processor. The controller determines what correction if any is needed to achieve the rotational profile along the first axis. If correction is needed, the object is rotated along the first axis. If no correction needed on the first axis, the object is rotated on the second axis. A pattern recognition algorithm may be run again to determine if correction is needed to achieve the rotational profile along the second axis. If no correction is needed, the object is returned to the surface and resumes movement along the path. Upon each state transition, the apparatus may determine remaining time before the next object approaches on the surface. If the time is insufficient to continue rotating the object, the object is returned to the surface.

In an embodiment, the following steps are carried out: An onion is in position 1 on a surface and it is desired for the object to be in position 2 on the surface. The height of the onion is measured with a height sensor. Four gripping elements move vertically toward the onion. A first pair of diametrically opposed gripping elements grip the onion and lift the onion. A camera captures a first image of the onion. A pattern recognition algorithm is applied to the first image of the onion and registers the X and Y coordinates of one or more features of the onion such as root, node, stem, neck, and meridian an lines, using the dead center of the onion in the first image as the origin of the axes. The controller receives the X and Y coordinates of the one or more features of the onion, generates a first rotational profile that represents the angle that the onion must be rotated to a desired position on a first axis, and converts the first rotational profile to motor counts and commands a first rotational actuator to rotate along the first axis. Two diametrically opposed appendages on the first pair of diametrically opposed gripping elements rotate the onion about a first axis. A second pair of diametrically opposed gripping elements grip the onion. The first pair of diametrically opposed gripping elements release the onion. The camera captures a second image of the onion. The pattern recognition algorithm is run again and the controller generates a second rotational profile that represents the angle that the onion must be rotated to a desired position on a first axis, and converts the second rotational profile to motor counts and commands a second rotational actuator to rotate along the second axis. Two diametrically opposed appendages on the second pair of diametrically opposed gripping elements rotate the onion about a second axis. The vertical actuator lowers the onion to the surface. Optionally, after rotation on each axis, the camera may capture additional images of the onion and additional rotational profiles along each axis may be generated by the controller to determine if the onion is in the desired position on each axis. Optionally, at any step of the preceding method, the controller may determine that there is not enough time to rotate the onion and may signal the vertical actuator to lower the onion to the surface.

Gripping Elements. The apparatus comprises four gripping elements. The four gripping elements comprise two pairs of diametrically opposed gripping elements. In an embodiment depicted in FIGS. 11-13, each gripping element 30a, 30b is connected to an arm 60, where the gripping element 30a, 30b is located at the end of the arm 60 proximal to the object 10 and distal to the frame 90. Whether the gripping elements are connected to arms, or alternatively, stand alone, the gripping elements are capable of two different movements. The vertical movement of the gripping elements moves the gripping elements in closer vertical proximity to the object. By way of example but not limitation, as depicted in FIG. 3, gripping elements 30a, 30b situated above the object 10 may move vertically down closer to the object 10. The horizontal movement of the gripping elements moves the gripping elements in closer horizontal proximity to the object. By way of example but not limitation, as depicted in FIGS. 4, 6 the gripping elements 30a, 30b may move horizontally closer to the object 10 to engage the object 10.

Appendages. In an embodiment, the apparatus comprises four appendages, comprising two pairs of diametrically opposed appendages. In the embodiments depicted in FIGS. 1-13, the gripping element 30a, 30b comprises a main body and an appendage 35a, 35b extending from the main body, the appendage 35a, 35b being the point of contact for the object 10. The appendage design may be optimized to achieve the rotational function of the gripping element. By way of example but not limitation, the shape, material, or stiffness of the gripping element may be optimized for a particular object. The appendage is capable of rotational movement. The rotational movement of the appendages moves a pair of diametrically opposed appendages in a way to achieve rotation of the object in a common direction. This is achieved by rotation of the two diametrically opposed appendages in opposite directions, one clockwise, and one counterclockwise. By way of example but not limitation, the appendages 35a of the two diametrically opposed gripping elements 30a depicted in FIG. 5 rotate the object 10 in a common direction along path G. In an embodiment comprising four arms 60 such as depicted in FIG. 11-13, the four arms 60 are capable of only the vertical movement and the horizontal movement. In this embodiment, movement of the four arms 60 vertically or horizontally also results in movement of the connected gripping elements 30a, 30b and appendages 35a, 35b. In this embodiment, the rotational movement of the appendages 35a, 35b to rotate the object 10 is independent from the movement of the four arms 60 and the gripping elements 30a, 30b.

Vertical Actuator. The apparatus comprises a vertical actuator that moves the four gripping elements vertically toward the object. The vertical actuator is operably connected to four gripping elements. In the embodiment of the invention where each gripping element 30a, 30b is connected to an arm 60, as depicted in FIGS. 11-13, the vertical actuator 80 is also operably connected to the four arms 60, as vertical movement of the four arms 60 will result in the same vertical movement of the four gripping elements 30a, 30b. In one embodiment, the apparatus comprises a single vertical actuator above the surface on which the object rests that serves to lower the gripping elements to the object. In another embodiment, as depicted in FIGS. 1-3, 8-10, the apparatus comprises a vertical actuator above the surface 40 as well as a second vertical actuator 50 below the surface 40 on which the object 10 rests that serves to raise the object 10 in closer proximity to the gripping elements 30a, 30b. The second vertical actuator 50 may, as depicted in FIGS. 1-3, 8-10, have an end effector comprising fingers 55 on which the object 10 rests. The fingers 55 may have tailored stiffness that cannot angle to lift the object 10 without collapsing. The use of a second vertical actuator to raise the object in closer proximity to the gripping elements is preferably employed when the object is small. The vertical actuator may be a ball screw or linear actuator. In an embodiment, the vertical actuator comprises two-stage actuation, gross and trim. In some embodiments, the vertical actuator comprises mechanical springs. In some embodiments, the vertical actuator comprises an air spring, providing bulk force as opposed to controlled force. In another embodiment, the vertical actuator comprises a rotational motor and linkage. In another embodiment, the vertical actuator is powered by pneumatics or hydraulics.

Horizontal Actuator. The apparatus comprises a horizontal actuator operably connected to the four gripping elements. The horizontal actuator functions to move each of the two pairs of diametrically opposed gripping elements to clamp onto the object. By way of example but not limitation, as depicted in FIGS. 4, 6 the gripping elements 30a, 30b may move horizontally closer to the object 10 to engage the object 10. In the embodiment depicted in FIG. 11, both the arms 60 and the gripping elements 30a, 30b are operably connected to the horizontal actuator such that the arms 60 and the gripping elements 30a, 30b move horizontally toward the object. In an alternative embodiment, the gripping element moves horizontally and the arms do not move horizontally. The horizontal actuator comprises synchronizer linkages such that a pair of diametrically opposed gripping elements will have synchronized horizontal movement away from and toward the object. In an embodiment, the horizontal actuator comprises a spin drive routed along the synchronizer linkage. The horizontal movement actuated by the horizontal actuator may be achieved by a linear or a rotational motor powered by electric, pneumatic, hydraulic, or cable clamp actuation.

Rotational Actuator. The rotation on a pair of diametrically opposed gripping elements functions to rotate the object in a common direction, meaning that the rotation of the two diametrically opposed gripping elements is opposite, one gripping element rotating in a clockwise fashion and the corresponding diametrically opposed gripping element rotating in a counterclockwise fashion, to achieve rotation of the object in a common direction. By way of example but not limitation, the appendages 35a of the two diametrically opposed gripping elements 30a depicted in FIG. 5 rotate the object 10 in a common direction along path G, which means that the actual appendages 35a rotate in opposite directions, one clockwise and one counterclockwise to achieve the rotation of the object 10 in a common direction along path G. In one embodiment, there are two stepper motors per pair of diametrically opposed gripping elements, wherein the two stepper motors distribute torque across both gripping elements of a pair for faster actuation. In another embodiment, a pair of diametrically opposed gripping elements comprises a first rotational actuator spring loaded in one direction and a second rotational actuator with a one way actuator. In another embodiment, there is a single spin motor per pair of diametrically opposed gripping elements driving movement of only one gripping element. In another embodiment, the rotational actuator comprises a single spin motor and the entire apparatus comprises a yaw axis turning the whole apparatus to achieve orientation along two axes. In one embodiment, the rotating function of the rotational actuators may be achieved by linear or rotational motors powered by electric, pneumatic, hydraulic, or cable clamp actuation. In an embodiment, the rotational motor comprises belt drive, gear drive, or linkage to a central synchronizer collar.

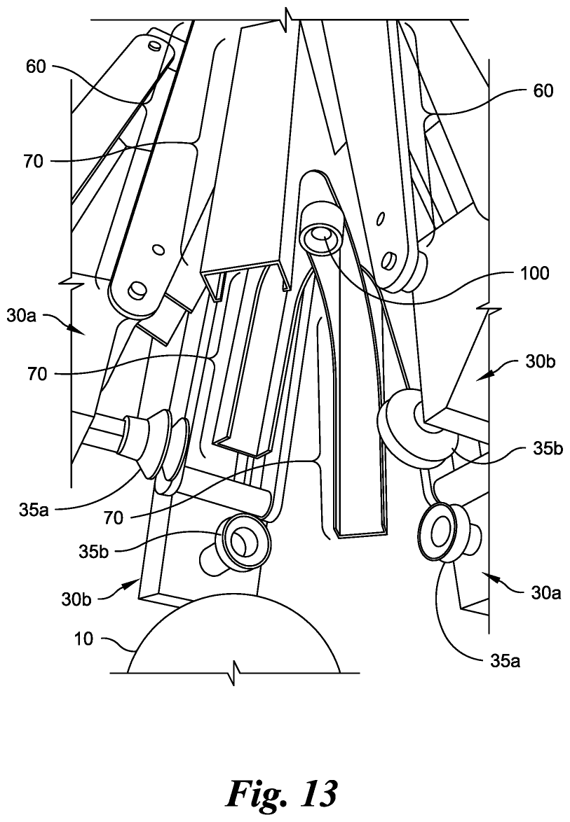

Camera. In some embodiments, the apparatus comprises a camera. In one embodiment, depicted in FIG. 13, the camera 100 is located at the apex of the hollow cavity formed by four arms 60 extending radially around the object 10. The camera captures at least one image of the object, which may serve as the basis for determining how to re-position the object. In an embodiment, the image of the object captured by the camera is processed by an image processor to register a feature of the object in the image along an orientation axis, and that registered feature along the orientation axis is relayed to a controller, which then creates a rotational profile of the object and relays to the rotational actuator information to rotate the object to the desired position. By way of example but not limitation, the camera may be a two-dimensional camera that captures a two-dimensional image of the object; a two-dimensional camera used to generate a three-dimensional model of the object by use of the silhouette of the object plus spin; a three-dimensional laser scanner; a camera capable of generating a video of about 15 frames per second; a camera capable of hyperspectral imaging; a camera with a polarizing filter to reduce glare on images the object; or a camera with settings optimized to capture images of the object. The camera may have a tracking feature to track the object before the conveyor surface has settled. In some embodiments, the camera is an Allied Vision Mako Series camera.

Image Processor. The apparatus may further comprise an image processor. The image processor receives an image of the object from the camera. The image processor may pre-process images received from the camera, such as removing blurs and shadows. In some embodiments, the image processor comprises a pattern recognition algorithm. The pattern recognition algorithm extracts a feature of the object from the image, and registers the feature location along an orientation axis of the image. In some embodiments, the pattern recognition algorithm registers a feature at X and Y coordinates of a two dimensional image of the object, with the dead center of the object in the two dimensional image being the origin of the X and Y axes. Any one or more recurring features present on the objects to be positioned can be used in the image processor. By way of example but not limitation, different object features that could be used in the image processor include roots (i.e., the bottom of the object), meridian lines (i.e., lines traversing the object between the top and bottom), nodes (i.e., the top of the object), stems, necks, and shape. In some embodiments, the pattern recognition algorithm comprises a neural network-based feature detector comprising a database of tagged features for deep learning and different object topologies. In some embodiments, the pattern recognition algorithm comprises custom software written in the C programming language. In some embodiments, the image processor carries out any or all of the functions of network communications, image capture, image processing, and output filtering.

Controller. The apparatus may further comprise a controller. The controller functions to translate input from components of the apparatus into movement to achieve desired re-positioning of the object. By way of example but not limitation, the controller may control any or all of the following: amount of vertical movement by the vertical actuator; amount of horizontal movement by the horizontal actuator; amount of rotation by the rotational actuators. In some embodiments, the controller functions to create the rotational profile of the object based on input from the image processor.

By way of example but not limitation, in controlling vertical movement, the controller may translate the height of the object measured by a height sensor to a desired vertical movement, then command the vertical actuator to move the amount of desired vertical movement. In some embodiments, the controller may use extra modifying terms to artificially optimize the geometry of the object to achieve desired movement. The controller may also include object-to-surface transition code tuning, which can (1) account for non-spherical object shapes; and (2) lower the gripping elements an optimal distance to achieve release of the object without the object becoming misaligned. The controller may also synchronize vertical movement in embodiments where there are two vertical actuators. The controller may synchronize horizontal movement of the horizontal actuator.

In controlling rotational movement, the controller may create one or more rotational profiles. Such rotational profiles comprises the one or more angles that the object must be rotated to achieve the desired object orientation. In some embodiments, the controller creates the rotational profile by translating feature location along an orientation axis provided by the image processor into an angle that the object must be rotated to move the features into a desired position.

In an embodiment, the controller generates a first rotational profile to determine the angle that the object must be rotated to achieve the desired object orientation along a first axis, and the controller generates a second rotational profile to determine the angle that the object must be rotated to achieve the desired object orientation along a second axis. The second rotational profile may be based on feature locations from one or more images taken before or after rotation along the first axis.

In some embodiments, a first rotational profile is created when the controller receives X and Y coordinates of an object feature from the image processor and converts the X and Y coordinates of the feature to a rotation angle along a first axis to achieve the desired position on the first axis by using an approximation of object diameter. By way of example but not limitation, the approximation of object diameter may be based on the height of the object measured by a height sensor. Once the controller has converted X and Y coordinates to rotation angles along the first axis, the controller may either convert the angle to motor counts and command a first rotational actuator to rotate along the first axis; or the controller may switch to control of a second rotational actuator. In some embodiments, the controller may create a second rotational profile for the first axis by receiving a second set of X and Y coordinates of an object feature and converting the second set of X and Y coordinates to a second rotation angle along a first axis. In some embodiments, the controller generates a rotational profile along a second axis by receiving additional X and Y coordinates of an object feature from the image processor and converting the additional set to a rotation angle along a second axis using the same process as conversion of X and Y coordinates to an angle for rotation along the first axis. The controller may either convert the angle to motor counts and command a second rotational actuator to rotate along the second axis; or the controller may switch to control of the vertical actuator and lower the object to the surface. In some embodiments, the controller may create a second rotational profile for the second axis by receiving a second set of X and Y coordinates of an object feature and converting the second set of X and Y coordinates to a second rotation angle along a second axis. The controller decision to command a rotational actuator to rotate along an axis may depend on, by way of example but not limitation, variables such as a set time remaining for rotation or the amount of correction needed along the axis to achieve the desired object position.

In some embodiments, the controller determines the time remaining for rotation of the object and commands the vertical actuator to lower the object to the surface if there is insufficient time. By way of example but not limitation, the controller may make this determination by a set value of time permitted for each object; how much time each type of action requires; or how fast the surface is moving. In some embodiments, the controller may determine that there is not enough time to perform rotation to achieve the desired position, the object is set down with rotation only along one axis or no rotation at all.

In some embodiments, the controller may account for errors in the image processor. In some embodiments, the controller creates the rotational profile by translating two-dimensional feature location into an object angle, wherein the geometry of the object is experimentally optimized with extra modifying terms and wherein the controller accounts for errors due to three-dimensional to two-dimensional information loss and changes in trigonometric function sensitivity at large angles. The controller may also include rotation logic tuning for speed; calculating for error by two-dimensional distance or by angle; or mapping the location of features on the object using a polar or a Cartesian approach. In some embodiments, the hardware component of the controller is B&R Industrial Automation's X20 Series Controller.

Height Sensor. In some embodiments, the apparatus comprises one or more height sensors. In one embodiment, as depicted in FIGS. 1-3, 8-10, the height sensor 20a, 20b comprises two separate sensors, one height sensor 20b below the surface 40 to measure the portion of the object 10 below the surface 40, and one height sensor 20a above the surface 40 to measure the portion of the object 10 above the surface 40. In another embodiment, the height sensor comprises only one height sensor above the surface to measure the portion of the object above the surface. In an embodiment, the height sensor comprises a feedback element communicating the position of the height sensor to the vertical actuator, wherein the movement actuated by the vertical actuator is a result of the height sensor position. By way of example but not limitation, in the embodiment depicted in FIG. 11, the height sensor 20a is operably connected to the vertical actuator 80 such that the position of the height sensor 20a effectively determines the movement actuated by the vertical actuator 80. The height sensor may be a potentiometer, optical encoder, Hall Effect encoder, linear variable differential transformer, or strain gage having either whisker or revolute joints. Alternatively, the height sensor is integrated with a camera and measures the portion of the object above the surface by a laser line projected on the object combined with the existing camera system to determine the widest spot of the object when the laser line vanishes, a static laser scanner station before clamping and rotation functions are carried out, a photodetector, or an electric eye array comprising horizontal light beams.

Light Fixture. The apparatus may further comprise a light fixture. By way of example but not limitation, as depicted in FIGS. 11-13, the light fixture 70 may extend radially around the center, forming an arch shape, to shine light on the object 10. In another embodiment the light fixture comprises mirrors mounted on the apparatus to further re-direct light from the central location where the object is situated. In another embodiment, the light fixture comprises a flat board mounted in between the arms around the camera. By way of example but not limitation, in some embodiments such flat board comprises a flat PCB light. In any of the foregoing embodiments, the light fixture is in radial symmetry with respect to the camera. The light fixture may be sealed against washdown on its own or, alternatively, may be enclosed in a seal with the camera. In some embodiments, the light fixture may be a flat fare light fixture, such as a flat circuit board with LED lights, surrounding the face of the camera lens. The light fixture may be mounted on a stationary part of the apparatus or, alternatively, may be mounted on a moving part of the apparatus as depicted in FIGS. 11-13, where the light fixture is mounted on the frame 90 from which the four arms 60 extend. In some embodiments, the light fixture comprises a light emitting diode (LED). The light fixture may include a diffusion material or filter to prevent overexposed highlights or glare on the object. The light fixture may emit white light or light of varied colors to optimally illuminate the object. The light fixture may have a polarizing filter. In one embodiment, to prevent shadows from blocking light emitted from the light fixture to the object, the light fixture or other parts of the apparatus may be made of a translucent material.

Arms. The apparatus may further comprise four arms extending vertically toward the surface. By way of example but not limitation, as depicted in FIGS. 11-13, the four arms 60 comprise two pairs of diametrically opposed arms. At the end of each arm 60 proximal to the object 10 and distal to the frame 90, a gripping element 30a, 30b is connected. The four arms 60 may form a hollow center mast, the apex of which allows placement of a camera 100, lighting, or cable routing, as depicted in FIGS. 11-13. The structure of the arms may be optimized to carry out object repositioning. By way of example but not limitation, the arms may be structured to have a scoop situated such that an object clamped between two arms rests on top of the scoop.

Frame. In some embodiments, the apparatus comprise a frame. The frame may connect all components of the apparatus or may just connect select components of the apparatus. The embodiment of the invention depicted in FIGS. 11-13 shows a frame 90 wherein the arms 60 of the apparatus extend in radial symmetry around the frame 90, extending toward the surface 40.

Surface. The apparatus functions above a surface. By way of example but not limitation, as depicted in FIGS. 1-13, the surface 40 may be a conveyor belt or a plate on top of a conveyor belt. In an embodiment, the surface is a plate on top of a conveyor belt, wherein the plate comprises a plurality of openings in which the object rests, wherein the opening has a diameter that is less than the diameter of the object.

Object. The apparatus may position a variety of objects. By way of example but not limitation, as depicted in FIGS. 1-13, the object 10 is a spherical object. In another embodiment, the object is non-spherical. In another embodiment, the object is any object having a somewhat spherical shape, with features identifying the top and bottom of the object. Such features may include, but are not limited to, roots (i.e., the bottom of the object), meridian lines (i.e., lines traversing the object between the top and bottom), nodes (i.e., the top of the object), stems, or necks. In any of the foregoing embodiments, the object is an onion.

What is claimed is:

1. An apparatus for positioning an object comprising:
four gripping elements comprising two pairs of diametrically opposed gripping elements;
four appendages, comprising two pairs of diametrically opposed appendages, operably connected to each of the four gripping elements;
a vertical actuator, wherein the vertical actuator is operably connected to the four gripping elements, wherein the vertical actuator moves the four gripping elements vertically relative to the object;
a horizontal actuator, wherein the horizontal actuator is operably connected to the four gripping elements, wherein the horizontal actuator moves each of the two pairs of diametrically opposed gripping elements from a first distance apart to a second distance apart, and wherein the second distance apart is sufficient to engage the object; and
a rotational actuator operably connected to the four appendages, wherein the rotational actuator rotates a first pair of the two pairs of diametrically opposed appendages in a first common direction about a first axis, wherein the rotational actuator rotates a second pair of the two pairs of diametrically opposed appendages in a second common direction about a second axis, wherein the second axis is perpendicular to the first axis.

2. The apparatus of claim 1, further comprising a camera to capture at least one image of the object; an image processor configured to receive input from the camera; and a controller configured to direct movement of the rotational actuator, wherein the controller determines a rotational profile of the object and directs movement of the rotational actuator based on the rotational profile.

3. The apparatus of claim 2, wherein the rotational profile is based on an object feature.

4. The apparatus of claim 2, wherein the image processor comprises a pattern recognition algorithm.

5. The apparatus of claim 1, further comprising a height sensor operably connected to the vertical actuator, wherein the height sensor measures a height of the object above a surface, and wherein the height of the object above the surface determines the amount of vertical movement of the gripping elements by the vertical actuator.

6. The apparatus of claim 1, further comprising a light fixture.

7. The apparatus of claim 6, wherein the light fixture is arranged in radial symmetry with respect to the camera.

8. The apparatus of claim 6, wherein the light fixture comprises a flat board surrounding the camera.

9. The apparatus of claim 1, further comprising four arms, each arm comprising a first end and a second end, wherein the first end is pivotly connected to a frame, wherein each of the four arms extends vertically from the frame to the second end, wherein the second end is proximal to the object, and wherein the second end of each arm comprises one of the four gripping elements.

10. The apparatus of claim 1, further comprising a controller, wherein the controller is operably connected to the four gripping elements and the four appendages, wherein the controller controls movement of the vertical actuator, the horizontal actuator, and the rotational actuator.

11. A method for positioning an object using the apparatus of claim 1, comprising:
measuring the object height with a height sensor;
moving the four gripping elements vertically toward the object with the vertical actuator;
moving a first pair of the two pairs of diametrically opposed gripping elements horizontally toward the object;
gripping the object with the first pair of the two pairs of diametrically opposed gripping elements;
lifting the object with the first pair of the two pairs of diametrically opposed gripping elements;
rotating the object about the first axis with the first pair of the two pairs of diametrically opposed appendages;
gripping the object with a second pair of the two pairs of diametrically opposed gripping elements;
releasing of the object by the first pair of the two pairs of diametrically opposed gripping elements; and
rotating the object about the second axis with the second pair of the two pairs of diametrically opposed appendages.

12. The method of claim 11, wherein the height sensor senses a height of the object above a surface.

13. The method of claim 11, further comprising the steps of detecting the object with a camera, wherein the camera captures at least one image of the object; and creating the rotational profile of the object to determine the amount of rotation.

14. The method of claim 13, wherein the step of creating the rotational profile of the object comprises extracting a feature of the object and registering the feature of the object along an orientation axis.

15. The method of claim 13, wherein the step of creating the rotational profile of the object is accomplished by a controller.

16. The method of claim 14, wherein the rotational profile is based on the feature of the object.

17. The method of claim 11, further comprising the step of exposing the object to a light.

18. The method of claim 11, wherein the object is a spherical object.

19. The method of claim 11, wherein the object is an onion.
